(19) United States
(12) Patent Application Publication
(10) Pub. No.: US 2025/0340315 A1
(43) Pub. Date: Nov. 6, 2025

(54) LANDING ASSIST DEVICE AND LANDING ASSIST METHOD

(71) Applicant: Nippon Telegraph and Telephone Corporation, Tokyo (JP)

(72) Inventors: Yuka SHINOZAKI, Musashino-shi, Tokyo (JP); Masaki HISADA, Musashino-shi, Tokyo (JP); Toru Nakamura, Musashino-shi, Tokyo (JP); Hiroshi MATSUBARA, Musashino-shi, Tokyo (JP); Tsuneko Kura, Musashino-shi, Tokyo (JP)

(21) Appl. No.: 18/867,719

(22) PCT Filed: Jun. 2, 2022
(86) PCT No.: PCT/JP2022/022424

§ 371 Date: Nov. 20, 2024

(51) Int. Cl. B64U 70/93; B64U 70/95

(52) U.S. Cl. CPC B64U 70/93; B64U 70/95

(57) ABSTRACT

A landing assist device includes a cart 30 movable on a port, and a catcher 31 disposed on the cart 30 and engageable with an attachment 11 attached to a drone 10. When the drone 10 descends to the port, the catcher 31 is brought close to and engaged with the attachment 11 from a lateral direction. The attachment 11 and the catcher 31 have a coil-spring shape.

### TECHNICAL FIELD

The present invention relates to a landing assist device and a landing assist method.

### BACKGROUND ART

In recent years, industrial use of drones has been expanding. There are various types of ports for drones to land depending on the application. For example, there is a port having a function of realizing safe landing of a drone by providing a marker that allows the drone to recognize the port, observing wind conditions around the port, or detecting an intruder into the port (Non Patent Literature 1).

### CITATION LIST

### Non Patent Literature

Non Patent Literature 1: “Butsuryuyo doroon pooto sisutemu (in Japanese)” (Drone Port System for Logistics), [online], Blue Innovation Co., Ltd., Internet <URL: https://www.blue-i.co.jp/service/logistic/dps/>

### SUMMARY OF INVENTION

### Technical Problem

However, in the conventional ports, there is a problem in that it is difficult to safely land under a situation where landing is difficult, such as wind blowing around the port or a landing place is on a rolling ship.

The present invention has been made in view of the above, and an object of the present invention is to safely land a flight vehicle even in a situation where landing of the flight vehicle is difficult.

### Solution to Problem

A landing assist device according to one aspect of the present invention includes: a cart that is movable on a landing point of a flight vehicle; and a catcher that is disposed on the cart and is engageable with an attachment attached to the flight vehicle, in which, when the flight vehicle descends to the landing point, the catcher is brought close to the attachment from a lateral direction and is engaged with the attachment.

A landing assist method according to one aspect of the present invention includes: bringing a catcher disposed on a cart close to a flight vehicle when the flight vehicle descends to a landing point; and engaging the catcher with an attachment attached to the flight vehicle.

### Advantageous Effects of Invention

According to the present invention, it is possible to safely land a flight vehicle even in a situation where it is difficult to land the flight vehicle.

### BRIEF DESCRIPTION OF DRAWINGS

FIG. 1 is a diagram illustrating an example of a configuration of a landing assist device according to a first example.

FIG. 2 is a diagram illustrating a state in which a drone is captured by the landing assist device.

FIG. 3 is a diagram illustrating an example of a configuration in which carts move on a rail.

FIG. 4 is a diagram illustrating an example of a configuration of a landing assist device according to a second example.

FIG. 5 is a diagram illustrating an example of a configuration of a landing assist device according to a third example.

FIG. 6 is a diagram illustrating an example of a state in which the drone is inclined.

FIG. 7 is a diagram illustrating an example of a state in which a port is inclined.

FIG. 8 is a diagram illustrating an example of variations of an attachment.

FIG. 9 is a diagram illustrating an example of variations of the attachment.

FIG. 10 is a diagram illustrating an example of variations of a catcher.

FIG. 11 is a diagram illustrating an example of variations of the catcher.

### DESCRIPTION OF EMBODIMENTS

An embodiment of the present invention will be described with hereinbelow reference to the drawings.

### First Example

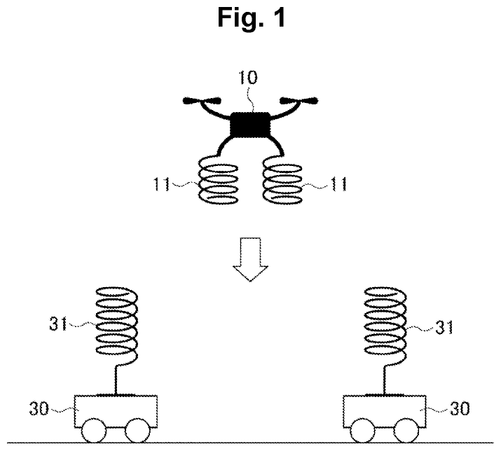

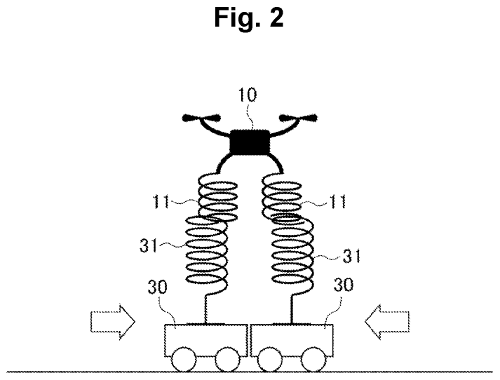

FIGS. 1 and 2 are diagrams illustrating an example of a configuration of a landing assist device according to a first example. The landing assist device of the first example includes attachments 11 attached to feet or a lower portion of a drone 10 and catchers 31 installed on respective carts 30. As illustrated in FIG. 2, the attachments 11 and the respective catchers 31 are engaged with each other to assist landing of the drone 10.

The drone 10 is an unmanned flight vehicle. The present invention is not limited to the drone 10, and can be applied to various flight vehicles.

Each of the attachments 11 and catchers 31 have a coil-spring shape with a wide winding pitch. The winding pitch may be any distance that allows the windings to engage between the windings of each other. When the attachment 11 and the catcher 31 have appropriate flexibility, an impact generated when the attachment 11 and the catcher 31 do not mesh well can be reduced. In addition, since it is necessary to support the drone 10 after capturing the drone 10, the catcher 31 also needs an appropriate strength.

The length of the catcher 31 is preferably longer than the length of the attachment 11. As a result, when the catcher 31 and the attachment 11 are engaged with each other, even if the drone 10 or a landing point is shaking, a distance change in the vertical direction due to the shaking can be absorbed by the length of the catcher 31.

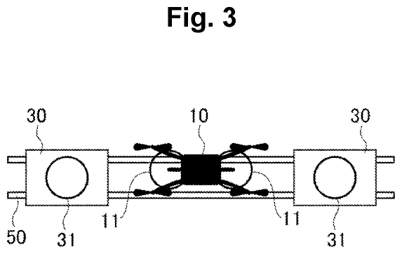

The cart 30 on which the catcher 31 is installed can freely move on a port. A person may move the cart 30, or the cart 30 may self-travel. As illustrated in FIG. 3, the carts 30 may move on rails 50 installed on the port. FIG. 3 is a view of the drone 10, the carts 30, and the rails 50 viewed from above.

Here, an example of a landing assist method using the landing assist device of the first example will be described.

The drone 10 flies above the port and descends toward the port. The port may be a landing point installed on the ground or may be a landing point installed on a ship.

Two carts 30 are arranged on both sides of a scheduled landing position, respectively. The two carts 30 may be arranged at both ends of the port, respectively. The drone 10 may descend toward an intermediate point between the two carts 30 as the scheduled landing position. In the case of manually moving the carts 30, persons who move the respective carts 30 are arranged at the two carts 30.

When the drone 10 descends, the timing is visually measured, the carts 30 are brought close to the drone 10, and the catchers 31 of the carts 30 and the attachments 11 of the drone 10 are respectively engaged from the lateral direction, and thereby the drone 10 is captured. For example, when the lower ends of the attachments 11 are below the upper ends of the catchers 31, the carts 30 are brought close to the drone 10. The interval between the carts 30 may be narrowed according to the height of the drone 10.

When each of the carts 30 can self-travel, a person moves the cart 30 by remote control. The cart 30 may automatically travel when a person presses a switch.

The drone 10 may hover at a height at which the catchers 31 and the attachments 11 are respectively engaged with each other.

When the carts 30 move on the rails 50, the drone 10 descends toward the rails 50. The two carts 30 may be moved in accordance with the descent position of the drone 10, or the drone 10 may descend toward an area between the two carts 30.

After the catchers 31 engages with the respective attachments 11, the drone 10 transitions to a control mode in which the drone 10 does not rise or turn. The drone 10 may stop functioning after capture. The drone 10 may detect that it is captured by the catchers 31 and may automatically switch a control mode, or may switch a control mode by an external signal or operation.

### Second Example

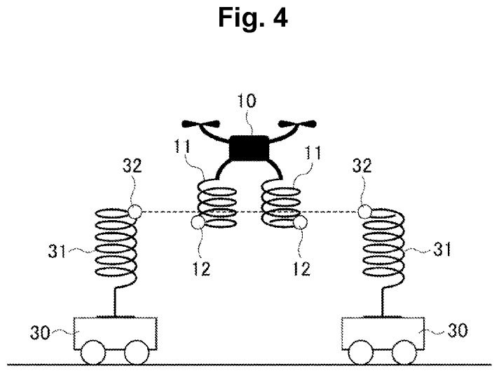

FIG. 4 is a diagram illustrating an example of a configuration of a landing assist device according to a second example. Similarly to the first example, the landing assist device of the second example includes the attachments 11 attached to feet or a lower portion of the drone 10 and the catchers 31 installed on the respective carts 30. The landing assist device of the second example further includes a sensor 12 at a lower portion of each attachment 11 and a sensor 32 at an upper portion of each catcher 31. The positional relationship between the lower portion of the attachment 11 and the upper portion of the catcher 31 is grasped by the sensors 12 and 32, and it is determined whether or not the attachment 11 has entered a capturable area of the catcher 31.

As the sensors 12 and 32, an infrared sensor, a camera, or the like can be used.

In the case of manually moving the carts 30, when the attachments 11 enter the capturable area of the catchers 31, a notification is made by sounding a buzzer or turning on a light. The buzzer or the light is disposed on the carts 30 or the drone 10. Upon receiving the notification, persons move the carts 30.

In a case where the carts 30 can self-travel, when it is detected that the attachments 11 have entered the capturable area of the catchers 31, the carts 30 move toward the drone 10. When the carts 30 move on the rails 50, the carts 30 moves in directions approaching each other.

### Third Example

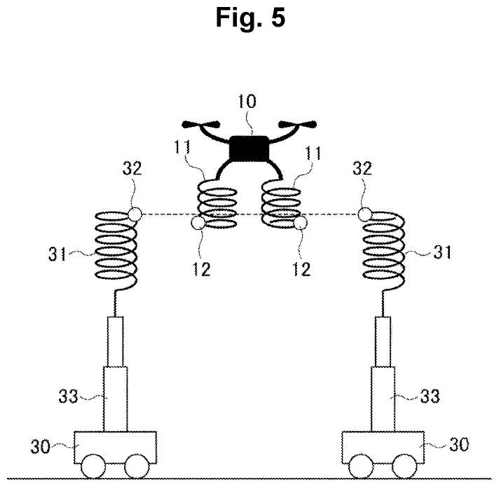

FIG. 5 is a diagram illustrating an example of a configuration of a landing assist device according to a third example. Similarly to the first and the second examples, the landing assist device of the third example includes the attachments 11 attached to feet or a lower portion of the drone 10 and the catchers 31 installed on the respective carts 30. The landing assist device of the third example further includes extendable portions 33 capable of changing the heights of the respective catchers 31. By extending the extendable portions 33, the drone 10 can be captured at a higher position.

The extendable portions 33 are disposed on the carts 30, and the catchers 31 are disposed on upper portions of the extendable portions 33, respectively. The heights of the catchers 31 can be changed by the respective extendable portions 33. As the extendable portions 33, for example, hydraulic cylinders, pneumatic cylinders, or electric cylinders may be used, or link mechanisms such as magic hands may be used.

The extendable portions 33 may automatically change the heights of the catchers 31 on the basis of information from the sensors 12 and 32, or a person may visually determine the position of the drone 10 and directly or remotely operate the extendable portions 33 to change the heights of the catchers 31. In a case where the catchers 31 capture the drone 10 at a high position, the extendable portions 33 may manually or automatically lower the positions of the catchers 31 at the time of collecting the drone 10.

The heights of the catchers 31 may be made the same by causing the extendable portions 33 of the respective two carts 30 to cooperate with each other or the heights of the catchers 31 need not be made the same.

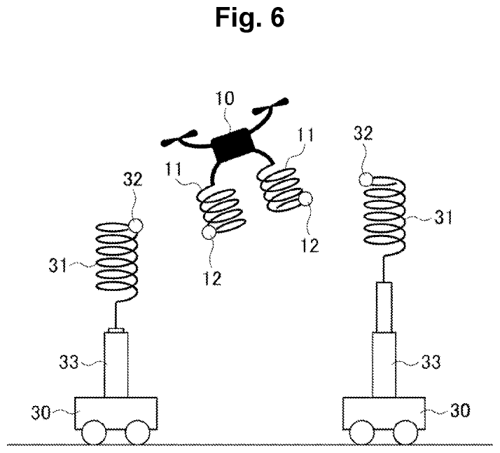

FIG. 6 is an example in which the drone 10 is inclined for some reason (for example, failure, strong wind, or the like). In this case, by adjusting the heights of the catchers 31 of the respective extendable portions 33 to the positions of the respective attachments 11, the drone 10 can be easily captured.

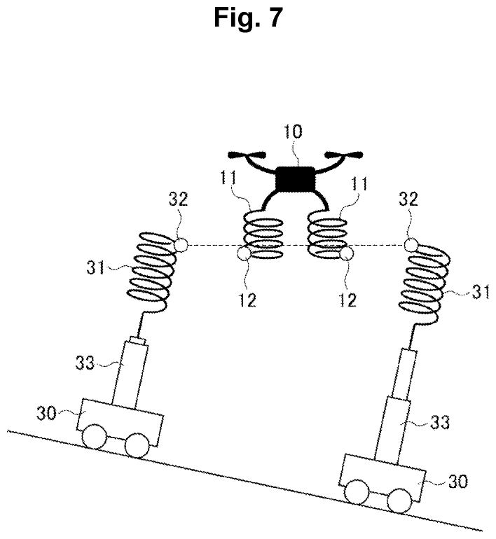

FIG. 7 is an example in which a port disposed on a ship or the like is inclined. In this case, the extendable portions 33 is extended in accordance with the inclination of the port so as to cancel the difference in height of the catchers 31 due to the inclination. The carts 30 may include inclination sensors, and the extendable portions 33 may be extended according to the measurement value of the inclination sensors, or the extendable portions 33 may be extended by the respective carts 30 on the basis of information from the sensors 12 and 32.

### Fourth Example

In a fourth example, variations of the attachment 11 and the catcher 31 will be described. The attachment 11 and the catcher 31 described in the fourth example can be applied to any of the first to the third examples.

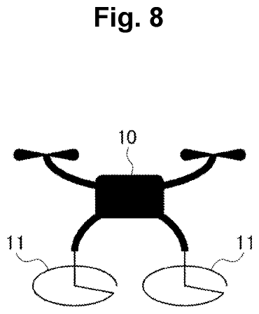

Each of the attachments 11 of FIG. 8 is a wire of one turn. The shape of the attachment 11 is not limited to a coil-spring shape, and may be any shape that can be captured by the catcher 31.

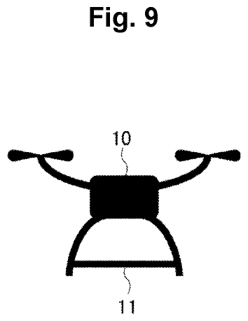

The attachment 11 of FIG. 9 has a structure in which the catcher 31 hooks the feet of the drone 10. As long as the feet of the drone 10 can be captured by the catcher 31, the structure may be used as the attachment 11.

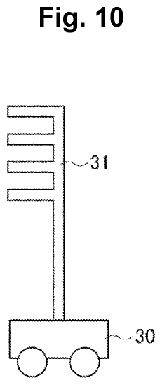

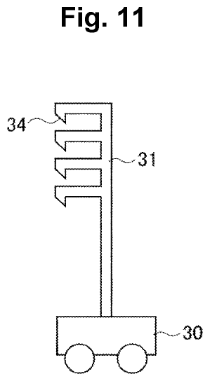

The catcher 31 in FIG. 10 has a comb-shaped structure. The catcher 31 of FIG. 11 includes barbs 34 on the comb shape. By providing the barbs 34, it is possible to prevent the captured drone 10 from falling off the catcher 31. Each of the windings of the catchers 31 having a coil-spring shape may include a barb.

Note that, in the first to the third examples, two attachments 11 are attached to the drone 10, but the present invention is not limited thereto. Only one attachment 11 may be attached to the drone 10, or three or more attachments 11 may be attached.

Further, in the first to the third examples, the drone 10 is captured by the two carts 30, but the present invention is not limited thereto. One cart 30 may capture the drone 10, or three or more carts 30 may be used. The number of attachments 11 and the number of catchers 31 need not be the same.

As described above, the landing assist device of the present embodiments includes the cart 30 movable on the port, and the catcher 31 disposed on the cart 30 and engageable with the attachment 11 attached to the drone 10. When the drone 10 descends to the port, the catcher 31 is brought close to and engaged with the attachment 11 from a lateral direction. When the attachment 11 and the catcher 31 are engaged with each other, the drone 10 can be captured in the air before the drone 10 lands on the port, and the drone can safely land in a case where strong wind blows or a ship pitches or rolls.

### REFERENCE SIGNS LIST

10 Drone
11 Attachment
12 Sensor
30 Cart
31 Catcher
32 Sensor
33 Extendable portion
50 Rail

1. A landing assist device comprising:
a cart that is movable on a landing point of a flight vehicle; and
a catcher that is disposed on the cart and is engageable with an attachment attached to the flight vehicle, wherein
when the flight vehicle descends to the landing point, the catcher is brought close to the attachment from a lateral direction and is engaged with the attachment.

2. The landing assist device according to claim 1, wherein
the catcher has a coil-spring shape, and engages the attachment between windings of a coil spring.

3. The landing assist device according to claim 1, comprising
a sensor that detects a positional relationship between the attachment and the catcher.

4. The landing assist device according to claim 1, comprising
an extendable portion that moves the catcher in an upper-lower direction.

5. The landing assist device according to claim 1, wherein the cart moves on a rail.

6. A landing assist method comprising:
bringing a catcher disposed on a cart close to a flight vehicle when the flight vehicle descends to a landing point; and
engaging the catcher with an attachment attached to the flight vehicle.

7. The landing assist device according to claim 1, wherein the flight vehicle comprises a drone.

8. The landing assist device according to claim 1, wherein a length of the catcher is greater than a length of the attachment.

9. The landing assist device according to claim 3, wherein the sensor comprises an infrared sensor or a camera.

10. The landing assist device according to claim 1, the catcher has a comb-shaped structure.

11. The landing assist device according to claim 1, further comprising an extendable portion capable of adjusting a height of the catcher that is disposed on the cart.

12. The landing assist device according to claim 11, wherein the extendable portion is disposed on the cart and the catcher is disposed on an upper portion of the extendable portion.

13. The landing assist device according to claim 11, wherein the extendable portion comprises at least one of a hydraulic cylinder, a pneumatic cylinder, or an electric cylinder.
